(19) United States
(12) Patent Application Publication
(10) Pub. No.: US 2021/0029736 A1
(43) Pub. Date: Jan. 28, 2021

(54) METHOD FOR SETTING TIMING ADVANCE OF RELAY NODE IN NEXT-GENERATION COMMUNICATION SYSTEM AND APPARATUS THEREFOR

(71) Applicant: LG ELECTRONICS INC., Englewood Cliffs, NJ (US)

(72) Inventors: Youngtae KIM, Seoul (KR); Yunjung YI, Seoul (KR); Huayue SONG, Seoul (KR); Hyunsoo KO, Seoul (KR)

(73) Assignee: LG ELECTRONICS INC., Seoul (KR)

(21) Appl. No.: 17/043,571

(22) PCT Filed: Apr. 5, 2019
(86) PCT No.: PCT/KR2019/004040

§ 371 Date: Sep. 29, 2020

Related U.S. Application Data
(60) Provisional application No. 62/653,660, filed on Apr. 6, 2018.

(51) Int. Cl. H04W 72/14; H04W 72/12; H04W 74/08; H04W 56/00

(52) U.S. Cl. CPC H04W 72/14; H04W 56/001; H04W 74/0833; H04W 72/1268

(57) ABSTRACT

Disclosed in the present application is a method for transmitting, by a terminal, an uplink signal in a next-generation wireless communication system. Specifically, the method comprises the steps of: receiving information on different timing advance values for a plurality of transmission points having the same cell index; receiving an uplink grant from one of the plurality of transmission points; and transmitting the uplink signal on the basis of the uplink grant, wherein the uplink grant indicates one of a plurality of beam indices for transmitting the uplink signal, and the uplink signal is transmitted with a timing advance associated with the indicated one beam index applied thereto.

### TECHNICAL FIELD

The present disclosure relates to a wireless communication system and, more particularly to a method of configuring timing advance of a relay node by a user equipment in a next-generation communication system, and an apparatus therefor.

### BACKGROUND ART

As more and more communication devices demand greater communication traffic as times go by, the next generation 5G system, which is wireless broadband communication, is being required over existing LTE systems. In the next generation 5G system named NewRAT, communication scenarios are classified into Enhanced Mobile BroadBand (eMBB), Ultra-Reliable Low-Latency Communication (URLLC), Massive Machine-Type Communications (mMTC), etc.

Here, eMBB is the next generation mobile communication scenario having such properties as High Spectrum Efficiency, High User Experienced Data Rate, High Peak Data Rate and the like, URLLC is the next generation mobile communication scenario having such properties as ultra reliability and ultra-low latency, ultra-high availability, and the like (e.g., V2X, emergency service, remote control), and mMTC is the next generation mobile communication scenario having such properties as low cost, low energy, short packet, massive connectivity and the like (e.g., IoT).

### DETAILED DESCRIPTION OF THE DISCLOSURE

### Technical Problems

Based on the above-described discussion, a method of configuring timing advance of a relay node by a user equipment in a next-generation communication system, and an apparatus therefor will be proposed hereinbelow.

### Technical Solutions

According to an aspect of the present invention, provided herein is a method of transmitting an uplink signal in a next-generation wireless communication system, including receiving information about different timing advance values for a plurality of transmission points having an equal cell index; receiving an uplink grant from one of the plural transmission points; and transmitting the uplink signal based on the uplink grant. The uplink grant indicates one of a plurality of beam indexes for transmitting the uplink signal, and the uplink signal is transmitted by applying timing advance associated with the indicated one beam index.

In another aspect of the present invention, provided herein is a user equipment (UE) in a next-generation wireless communication system, including a wireless communication module; and at least one processor connected to the wireless communication module. The at least one processor controls the wireless communication module to receive information about different timing advance values for a plurality of transmission points having an equal cell index, receive an uplink grant from one of the plural transmission points, and transmit the uplink signal based on the uplink grant. The uplink grant indicates one of a plurality of beam indexes for transmitting the uplink signal. The uplink signal is transmitted by applying timing advance associated with the indicated one beam index.

The information about the timing advance values may be received through a random access response signal from one or more of the plural transmission points.

The plural transmission points may include a doner base station and a relay node connected to the doner base station.

The plural transmission points having the equal cell index may belong to different timing advance groups.

### Advantageous Effects

According to an embodiment of the present disclosure, a UE may more efficiently configure timing advance of a relay node in a next-generation communication system.

It will be appreciated by persons skilled in the art that the effects that can be achieved through the present disclosure are not limited to what has been particularly described hereinabove and other advantages of the present disclosure will be more clearly understood from the following detailed description.

### DESCRIPTION OF DRAWINGS

FIG. 1 illustrates a control-plane protocol stack and a user-plane protocol stack in a radio interface protocol architecture conforming to a 3rd Generation Partnership Project (3GPP) radio access network standard between a User Equipment (UE) and an Evolved UMTS Terrestrial Radio Access Network (E-UTRAN).

FIG. 2 illustrates physical channels and a general signal transmission method using the physical channels in a 3GPP system.

FIG. 3 is a diagram for an example of a structure of a radio frame used by an LTE system.

FIGS. 4 to 6 are diagrams to describe structures of a radio frame and slot used in an NR system.

FIG. 7 abstractly shows a hybrid beamforming structure in aspects of Transceiver Unit (TXRU) and physical antenna.

FIG. 8 illustrates a beam sweeping operation for a synchronization signal and system information in a downlink transmission process.

FIG. 9 illustrates an example of a cell of a New Radio access technology (NR) system.

FIG. 10 illustrates an example of configuring TA values of a relay node and a DgNB by a UE.

FIG. 11 is a flowchart illustrating an example of configuring a plurality of TA values according to an embodiment of the present disclosure.

FIG. 12 is a block diagram showing components of a wireless device implementing the present disclosure.

### BEST MODE FOR CARRYING OUT THE DISCLOSURE

The configuration, operation, and other features of the present disclosure will readily be understood with embodiments of the present disclosure described with reference to the attached drawings. Embodiments of the present disclosure as set forth herein are examples in which the technical features of the present disclosure are applied to a 3rd Generation Partnership Project (3GPP) system.

While embodiments of the present disclosure are described in the context of Long Term Evolution (LTE) and LTE-Advanced (LTE-A) systems, they are purely exemplary. Therefore, the embodiments of the present disclosure are applicable to any other communication system as long as the above definitions are valid for the communication system.

Further, the term ‘Base Station (BS)’ may be used to cover the meanings of terms including Remote Radio Head (RRH), eNB, Transmission Point (TP), Reception Point (RP), relay, etc.

The 3GPP based communication standard defines downlink physical channels corresponding to resource elements carrying information originating from an upper layer and downlink physical channels corresponding to resource elements failing to carry information originating from the upper layer despite being used by a physical layer. For example, Physical Downlink Shared Channel (PDSCH), Physical Broadcast Channel (PBCH), Physical Multicast Channel (PMCH), Physical Control Format Indicator Channel (PCFICH), Physical Downlink Control Channel (PDCCH) and Physical Hybrid ARQ Indicator Channel (PHICH) are defined, and a resource signal and a synchronization signal are defined as downlink physical signals. A Reference Signal (RS) means a signal of a predefined special waveform known to both a gNB and a UE and may be referred to as a pilot. For example, a cell-specific RS), a UE-specific RS (UE-RS), a positioning RS (PRS) and a Channel State Information-R (CSI-RS) are defined as downlink reference signals. The 3GPP LTE/LTE-A standard defines uplink physical channels corresponding to resource elements carrying information originating from an upper layer and uplink physical channels corresponding to resource elements failing to carry information originating from the upper layer despite being used by a physical layer. For example, Physical Uplink Shared Channel (PUSCH), Physical Uplink Control Channel (PUCCH) and Physical Random Access Channel (PRACH) are defined as uplink physical channels, and Demodulation Reference Signal (DMRS) for an uplink control/data signal and Sounding Reference Signal (SRS) used for uplink channel measurement are defined.

In the present disclosure, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present disclosure, particularly, a time-frequency resource or Resource Element (RE) allocated or belonging to PDCCH/PCFICH/PHICH/PDSCH/PUCCH/PUSCH/PRACH is referred to as PDCCH/PCFICH/PHICH/PDS CH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDS CH.

Hereinafter, a CRS/DMRS/CSI-RS/SRS/UE-RS allocated or configured OFDM symbol/subcarrier/RE will be referred to as a CRS/DMRS/CSI-RS/SRS/UE-RS symbol/carrier/subcarrier/RE. For example, a Tracking RS (TRS) allocated or configured OFDM symbol will be referred to as a TRS symbol, a TRS allocated or configured subcarrier will be referred to as a TRS symbol, a TRS allocated or configured subcarrier will be referred to as a TRS subcarrier, and a TRS allocated or configured RE will be referred to as a TRS RE. Moreover, a subframe configured for TRS transmission will be referred to as a TRS subframe. A broadcast signal transmitted subframe will be referred to as a broadcast subframe or a PBCH subframe, and a synchronization signal (e.g., PSS and/or SSS) transmitted subframe will be referred to as a synchronization signal subframe or a PSS/SSS subframe. A PSS/SSS allocated or configured OFDM symbol/subcarrier/RE will be referred to as a PSS/SSS symbol/subcarrier/RE.

In the present disclosure, a CRS port, a UE-RS port, a CSI-RS port and a TRS port refer to an antenna port configured to transmit a CRS, an antenna port configured to transmit a UE-RS, an antenna port configured to transmit a CSI-RS and an antenna port configured to transmit a TRS, respectively. Antenna ports configured to transmit CRSs may be distinguished from each other by positions of REs occupied by the CRS according to CRS ports, respectively. Antenna ports configured to transmit UE-RSs may be distinguished from each other by positions of REs occupied by the UE-RS according to UE-RS ports, respectively. Antenna ports configured to transmit CSI-RSs may be distinguished from each other by positions of REs occupied by the CSI-RS according to CSI-RS ports, respectively. Therefore, the term ‘CRS/UE-RS/CSI-RS/TRS port’ may be used as a term referring to a pattern of REs occupied by a CRS/UE-RS/CSI-RS/TRS in a predetermined resource region.

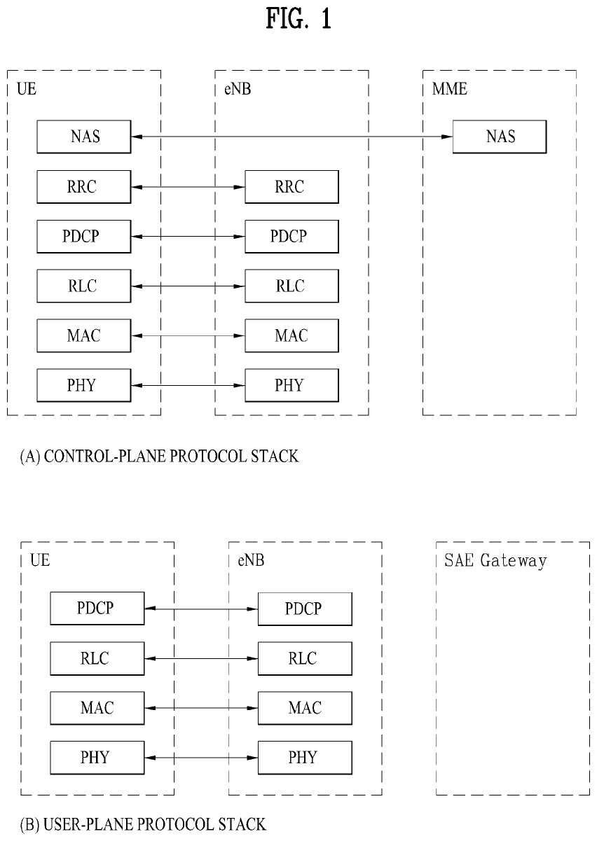

FIG. 1 illustrates control-plane and user-plane protocol stacks in a radio interface protocol architecture conforming to a 3GPP wireless access network standard between a User Equipment (UE) and an Evolved UMTS Terrestrial Radio Access Network (E-UTRAN). The control plane is a path in which the UE and the E-UTRAN transmit control messages to manage calls, and the user plane is a path in which data generated from an application layer, for example, voice data or Internet packet data is transmitted.

A PHYsical (PHY) layer at Layer 1 (L1) provides information transfer service to its higher layer, a Medium Access Control (MAC) layer. The PHY layer is connected to the MAC layer via transport channels. The transport channels deliver data between the MAC layer and the PHY layer. Data is transmitted on physical channels between the PHY layers of a transmitter and a receiver. The physical channels use time and frequency as radio resources. Specifically, the physical channels are modulated in Orthogonal Frequency Division Multiple Access (OFDMA) for Downlink (DL) and in Single Carrier Frequency Division Multiple Access (SC-FDMA) for Uplink (UL).

The MAC layer at Layer 2 (L2) provides service to its higher layer, a Radio Link Control (RLC) layer via logical channels. The RLC layer at L2 supports reliable data transmission. RLC functionality may be implemented in a function block of the MAC layer. A Packet Data Convergence Protocol (PDCP) layer at L2 performs header compression to reduce the amount of unnecessary control information and thus efficiently transmit Internet Protocol (IP) packets such as IP version 4 (IPv4) or IP version 6 (IPv6) packets via an air interface having a narrow bandwidth.

A Radio Resource Control (RRC) layer at the lowest part of Layer 3 (or L3) is defined only on the control plane. The RRC layer controls logical channels, transport channels, and physical channels in relation to configuration, reconfiguration, and release of radio bearers. A radio bearer refers to a service provided at L2, for data transmission between the UE and the E-UTRAN. For this purpose, the RRC layers of the UE and the E-UTRAN exchange RRC messages with each other. If an RRC connection is established between the UE and the E-UTRAN, the UE is in RRC Connected mode and otherwise, the UE is in RRC Idle mode. A Non-Access Stratum (NAS) layer above the RRC layer performs functions including session management and mobility management.

DL transport channels used to deliver data from the E-UTRAN to UEs include a Broadcast Channel (BCH) carrying system information, a Paging Channel (PCH) carrying a paging message, and a Shared Channel (SCH) carrying user traffic or a control message. DL multicast traffic or control messages or DL broadcast traffic or control messages may be transmitted on a DL SCH or a separately defined DL Multicast Channel (MCH). UL transport channels used to deliver data from a UE to the E-UTRAN include a Random Access Channel (RACH) carrying an initial control message and a UL SCH carrying user traffic or a control message. Logical channels that are defined above transport channels and mapped to the transport channels include a Broadcast Control Channel (BCCH), a Paging Control Channel (PCCH), a Common Control Channel (CCCH), a Multicast Control Channel (MCCH), a Multicast Traffic Channel (MTCH), etc.

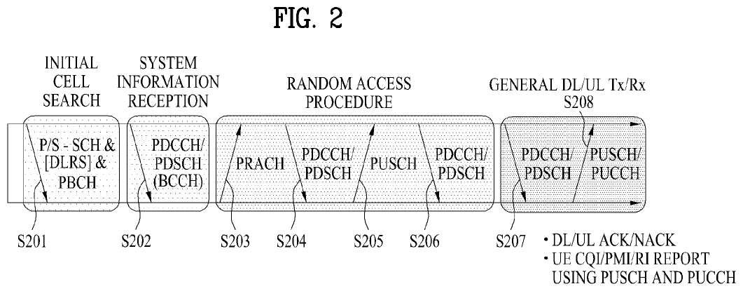

FIG. 2 illustrates physical channels and a general method for transmitting signals on the physical channels in the 3GPP system.

Referring to FIG. 2, when a UE is powered on or enters a new cell, the UE performs initial cell search (S201). The initial cell search involves acquisition of synchronization to an eNB. Specifically, the UE synchronizes its timing to the eNB and acquires a cell Identifier (ID) and other information by receiving a Primary Synchronization Channel (P-SCH) and a Secondary Synchronization Channel (S-SCH) from the eNB. Then the UE may acquire information broadcast in the cell by receiving a Physical Broadcast Channel (PBCH) from the eNB. During the initial cell search, the UE may monitor a DL channel state by receiving a DownLink Reference Signal (DL RS).

After the initial cell search, the UE may acquire detailed system information by receiving a Physical Downlink Control Channel (PDCCH) and receiving a Physical Downlink Shared Channel (PDSCH) based on information included in the PDCCH (S202).

If the UE initially accesses the eNB or has no radio resources for signal transmission to the eNB, the UE may perform a random access procedure with the eNB (S203 to S206). In the random access procedure, the UE may transmit a predetermined sequence as a preamble on a Physical Random Access Channel (PRACH) (S203 and S205) and may receive a response message to the preamble on a PDCCH and a PDSCH associated with the PDCCH (S204 and S206). In the case of a contention-based RACH, the UE may additionally perform a contention resolution procedure.

After the above procedure, the UE may receive a PDCCH and/or a PDSCH from the eNB (S207) and transmit a Physical Uplink Shared Channel (PUSCH) and/or a Physical Uplink Control Channel (PUCCH) to the eNB (S208), which is a general DL and UL signal transmission procedure. Particularly, the UE receives Downlink Control Information (DCI) on a PDCCH. Herein, the DCI includes control information such as resource allocation information for the UE. Different DCI formats are defined according to different usages of DCI.

Control information that the UE transmits to the eNB on the UL or receives from the eNB on the DL includes a DL/UL ACKnowledgment/Negative ACKnowledgment (ACK/NACK) signal, a Channel Quality Indicator (CQI), a Precoding Matrix Index (PMI), a Rank Indicator (RI), etc. In the 3GPP LTE system, the UE may transmit control information such as a CQI, a PMI, an RI, etc. on a PUSCH and/or a PUCCH.

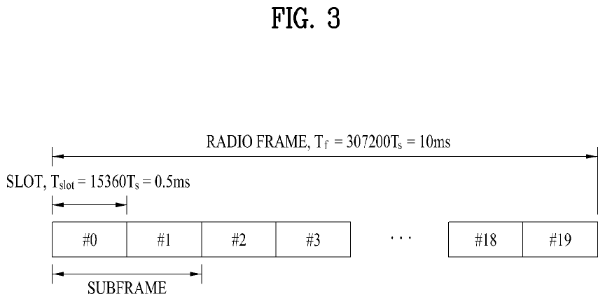

FIG. 3 is a diagram for an example of a structure of a radio frame used by an LTE system.

Referring to FIG. 3, a radio frame has a length of 10 ms (327200×Ts) and is constructed with 10 subframes in equal size. Each of the subframes has a length of 1 ms and is constructed with two slots. Each of the slots has a length of 0.5 ms (15360×Ts). In this case, Ts indicates a sampling time and is expressed as Ts=1/(15 kHz×2048)=3.2552×10−8 (about 33 ns). The slot includes a plurality of OFDM symbols in a time domain and includes a plurality of resource blocks (RB) in a frequency domain. In the LTE system, one resource block includes ‘12 subcarriers×7 or 6 OFDM symbols’. A transmission time interval (TTI), which is a unit time for transmitting data, can be determined by at least one subframe unit. The above described structure of the radio frame is just exemplary. And, the number of subframes included in a radio frame, the number of slots included in a subframe and/or the number of OFDM symbols included in a slot can be modified in various ways.

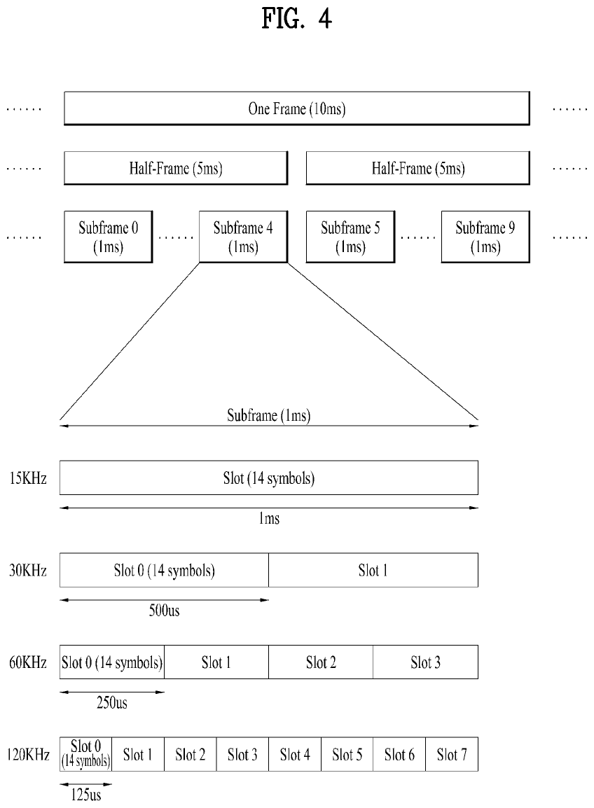

FIG. 4 shows an example of a structure of a radio frame used in NR.

UL/DL transmission in NR is configured with a frame. A radio frame has a length of 10 ms and is defined as 25 ms Half-Frames (HFs). The half-frame is defined as 5 lms SubFrames (SFs). A subframe is divided into one or more slots and the number of slots in the subframe depends of SubCarrier Spacing (SCS). Each slot includes 12 or 14 OFDM(A) symbols depending on a Cyclic Prefix (CP). When a normal CP is used, each slot includes 14 symbols. When an extended CP is used, each slot includes 12 symbols. Here, symbols may include OFDM symbols (or CP-OFDM symbols), SC-FDMA symbols (or DFT-s-OFDM symbols).

In the NR system, OFDM(A) numerology (e.g., SCS, CP length, etc.) may be configured differently among a plurality of cells aggregated for a single UE. Accordingly, (absolute time) interval of a time resource (e.g., SF, slot or TTI) (referred to as Time Unit (TU) for clarity) configured with the same number of symbols may be configured differently among the aggregated cells.

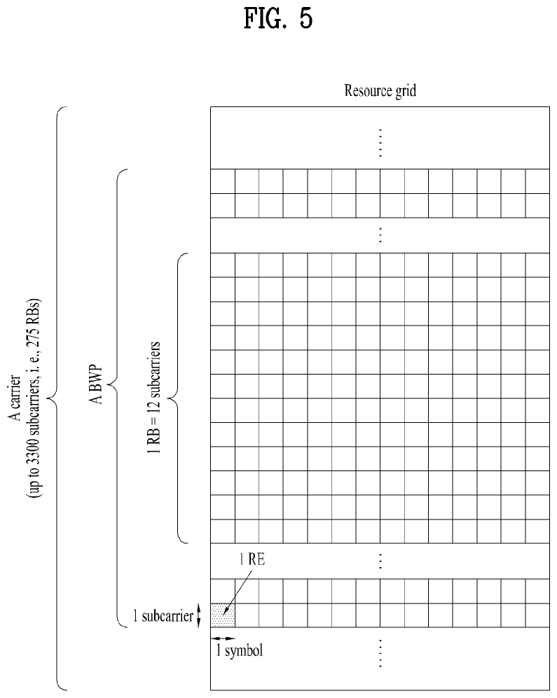

FIG. 5 exemplarily shows a slot structure of an NR frame. A slot includes a plurality of symbols in a time domain. For example, in case of a normal CP, a single slot includes 7 symbols. In case of an extended CP, a single slot includes 6 symbols. A carrier includes a plurality of subcarriers in a frequency domain. A Resource Block (RB) is defined as a plurality of contiguous subcarriers in the frequency domain. A BandWidth Part (BWP) is defined as a plurality of contiguous (P)RBs in the frequency domain and may correspond to one numerology (e.g., SCS, CP length, etc.). A carrier may include maximum N (e.g., 5) BWPs. Data communication is performed through an activated BWP, and a single BWP can be activated only for a single UE. Each element in a resource grid is referred to as a Resource Element (RE), and may have a single complex symbol mapped thereto.

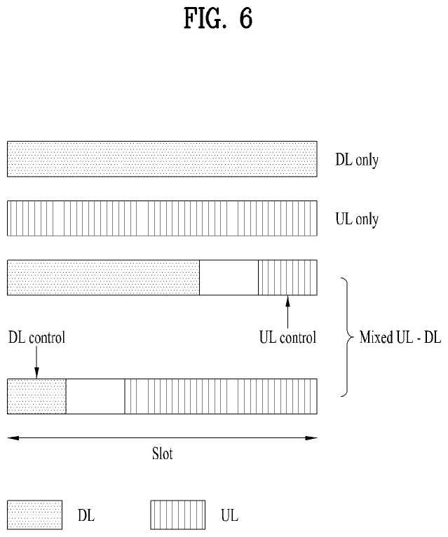

FIG. 6 shows a structure of a self-contained slot. In the NR system, a frame is characterized in having a self-contained structure that DL control channel, DL or UL data, UL control channel and the like can be included all in a single slot. For example, first N symbols in a slot may be used to transmit a DL control channel (hereinafter, DL control region), and last M symbols in the slot may be used to transmit a UL control channel (hereinafter, UL control region). N and M are integers equal to or greater than 0. A resource region (hereinafter, data region) located between the DL control region and the UL control region may be used for DL or UL data transmission. For example, the following configuration may be considered. Each interval is listed in order of time.

1. DL only configuration

2. UL only configuration

3. Mixed UL-DL configuration

−DL region+GP (Guard Period)+UL control region

−DL control region+GP+UL region

* DL region: (i) DL data region, (ii) DL control region+DL data region

* UL region: (i) UL data region, (ii) UL data region+UL control region

PDCCH may be transmitted in a DL control region, and PDSCH may be transmitted in a DL data region. PUCCH may be transmitted in a UL control region, and PUSCH may be transmitted in a UL data region. Downlink Control Information (DCI), e.g., DL data scheduling information, UL data scheduling information and the like may be transmitted on PDCCH. Uplink Control Information (UCI), e.g., Positive Acknowledgement/Negative Acknowledgement (ACK/NACK) information on DL data, Channel State Information (CSI), Scheduling Request (SR) and the like may be transmitted on PUCCH. GP provides a time gap in a process for a BS and UE to switch to Rx mode from Tx mode, and vice versa. Some symbols of a timing of switching from DL to UL in a subframe may be configured as a GP.

Meanwhile, the NR system is considering a scheme of using a ultrahigh frequency band (e.g., frequency band over 6 GHz) in order to transmit data to a multitude of users while maintain a high transmission rate using a wide frequency band. Yet, since the ultrahigh frequency band uses a too high frequency band, it is characterized in that signal attenuation due to a distance appears very rapidly. Therefore, in order to compensate for the rapid propagation attenuation characteristic, the NR system, which uses a frequency band over 6 GHz, uses a narrow beam transmission method of transmitting a signal by gathering energy not in omni-direction but in a specific direction. The NR system uses the narrow beam transmission method, thereby solving a problem of reduction of the coverage due to the rapid propagation attenuation. Yet, in case of providing a service using a single narrow beam only, a range for a single BS to provide a service is narrowed. Therefore, a BS may provide a service on broadband by gathering a multitude of narrow beams.

Since a wavelength is shortened on a ultrahigh frequency band, i.e., a millimeter Wave (mmW) band, a plurality of antenna elements may be installed in the same area. For example, in case of 30-GHz band having a wavelength of about 1 cm, total 100 antenna elements may be installed in 5 cm×5 cm panel with an 0.5-lamda interval in form of a 2-dimennsional array. Hence, on the mmW band, a method of increasing a coverage using a plurality of antenna elements or raising a throughput is considered.

As a method of forming a narrow beam on a mmW band, a beamforming scheme, which increases energy in a specific direction only in a manner that a BS or UE transmits the same signal through a plurality of antennas using an appropriate phase difference, is mainly considered. The beamforming scheme may include a digital beamforming of generating a phase difference in a digital baseband signal, an analog beamforming of generating a phase difference in a modulated analog signal using a time delay (i.e., a cyclic shift), a hybrid beamforming using both a digital beamforming and an analog beamforming, etc. If a Transceiver Unit (TXRU) is provided to enable transmission poser and phase adjustment per antenna element, an independent beamforming per frequency resource is possible. Yet, if TXRUs are installed at all the 100 antenna elements, it may be less efficient in aspect of costs. Namely, the mmW band uses a number of antennas to compensate for the rapid propagation attenuation characteristic, and the digital beamforming needs an RF component (e.g., a digital-to-analog converter (DAC), a mixer, a power amplifier, a linear amplifier, etc.) per antenna. Hence, in order to implement a digital beamforming on a mmW band, there is a problem that the price of a communication device increases. Hence, in case that many antennas are required like the mmW band, the use of the analog or hybrid beamforming scheme is considered. According to the analog beamforming scheme, a plurality of antenna elements are mapped to a single TXRU and a direction of a beam is adjusted by an analog phase shifter. Yet, as the analog beamforming scheme can generate a single beam direction only on the full band, it is disadvantageously incapable of providing a frequency selective BeamForming (BF). The hybrid beamforming scheme has an intermediate form between the digital beamforming scheme and the analog beamforming scheme and includes a scheme of having B TXRUs (where B is smaller than Q) when there are Q antenna elements. According to the hybrid beamforming scheme, although there is a difference according to the connection ways between Q antenna elements and B TXRUs, directions of simultaneously transmittable beams are limited to be equal to or smaller than B.

As described above, since digital BF performs signal processing on a digital baseband signal to transmit or a received digital baseband signal, a signal can be simultaneously transmitted or received in several direction using multiple beams. On the other hand, since analog BF performs beamforming in a state that an analog signal to be transmitted or a received analog signal is modulated, a signal cannot be simultaneously transmitted or received in multiple directions exceeding a range covered by a single beam. Normally, a BS performs communication with a multitude of users simultaneously using wideband transmission or multi-antenna characteristics. In case that the BS uses analog or hybrid beamforming and forms an analog beam in a single beam direction, the BS has no choice but to communicate with users included in the same beam direction due to the characteristics of the analog beamforming. RACH resource allocation and resource utilization scheme of a base station according to the present disclosure is proposed by reflecting the restrictions attributed to the analog or hybrid beamforming characteristics.

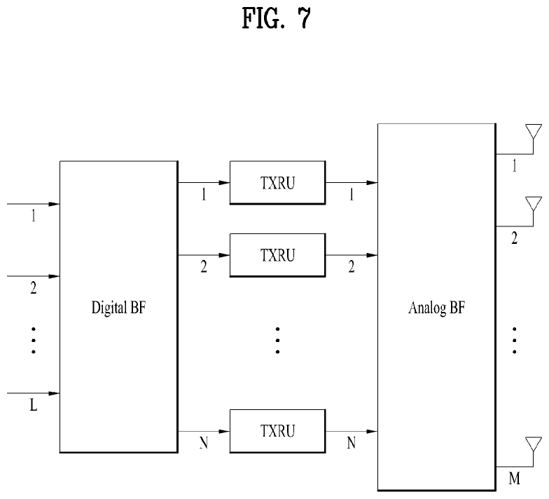

FIG. 7 abstractly shows a hybrid beamforming structure in aspects of Transceiver Unit (TXRU) and physical antenna.

When a multitude of antennas are used, a hybrid beamforming scheme of combining a digital beamforming and an analog beamforming together is on the rise. Here, the analog beamforming (or an RF beamforming) means an operation that an RF unit performs precoding (or combining). In the hybrid beamforming, each of a baseband unit and an RF unit performs a precoding (or combining), whereby performance proximate to the digital beamforming can be advantageously obtained while the number of RF chains and the number of D/A (or A/D) converters are reduced. For clarity, a hybrid beamforming structure may be represented as N TXRUs and M physical antennas. A digital beamforming for L data layers to be transmitted from a transmitting end may be represented as an N-by-L matrix. Thereafter, the N converted digital signals are converted into an analog signal through TXRU and an analog beamforming represented as an M-by-N matrix is then applied thereto.

In FIG. 7, the number of digital beams is L and the number of analog beams is N. In an NR system, a BS is designed to change an analog beamforming in a symbol unit, whereby a direction of supporting an efficient beamforming for a UE located in a specific area is considered. Moreover, when N TXRUs and M RF antennas are defined as a single antenna panel, an NR system considers a scheme of employing a plurality of antenna panels to which independent hybrid beamforming is applicable. Thus, when a BS uses a plurality of analog beams, an analog beam advantageous for signal reception may differ per UE. Hence, regarding a synchronization signal, system information, paging and the like at least, a beam sweeping operation is considered as follows. Namely, a BS changes a plurality of analog beams, which are to be applied in a specific slot or SubFrame (SF), per symbol, whereby all UEs may have opportunity in receiving a signal.

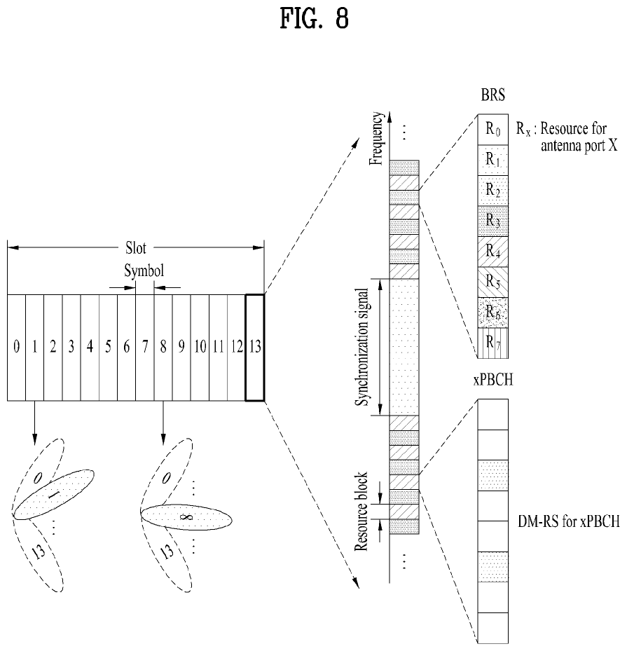

FIG. 8 illustrates a beam sweeping operation for a synchronization signal and system information in a downlink transmission process.

In FIG. 8, a physical resource or a physical channel, on which system information of the New RAT system is broadcasted, is referred to as Physical Broadcast Channel (xPBCH). In this case, analog beams belonging to different antenna panels in a single symbol may be transmitted simultaneously, and a method of introducing a Beam Reference Signal (BRS), which is a Reference Signal (RS), transmitted for a single analog beam corresponding to a specific antenna panel, as shown in FIG. 8, is under discussion to measure a channel per analog beam. The BRS may be defined for a plurality of antenna ports, and each antenna port of the BRS may correspond to a single analog beam. In this case, unlike the BRS, a synchronization signal or xPBCH may be transmitted for all analog beams included in an analog beam group to be received well by a random UE.

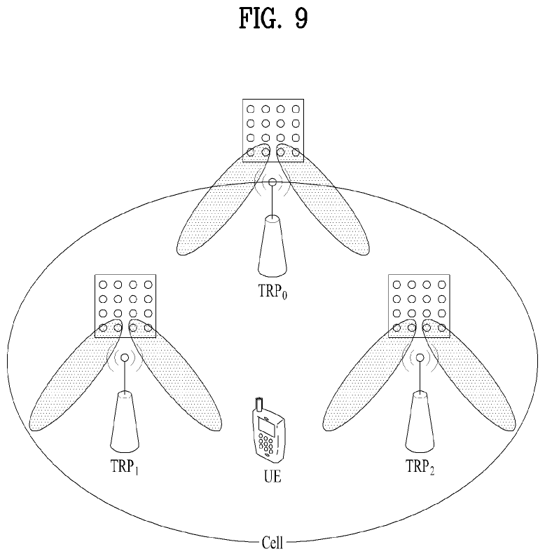

FIG. 9 illustrates an example of a cell of a New Radio access technology (NR) system.

Referring to FIG. 9, in a NR system, unlike the case in which one BS forms one cell in a wireless communication system such as the existing LTE or the like, a scheme in which a plurality of Transmission Reception Points (TRPs) form one cell is under discussion. If a plurality of TRPs form one cell, although a RTP that services a UE is changed, seamless communication is possible. Hence, mobility management of a UE is advantageously facilitated.

In the LTE/LTE-A system, PSS/SSS is transmitted in omni-directions. Unlike this, in the NR system, a following method is considered. Namely, a gNB applying mmWave performs a beamforming on a signal such as PSS, SSS, PBCH or the like by turning a direction of a beam omni-directionally and then transmits the corresponding signal. In doing so, transceiving a signal by turning a beam direction is referred to as a beam sweeping or a beam scanning. In the present disclosure, ‘beam sweeping’ indicates an operation of a transmitter side and ‘beam scanning’ indicates an operation of a receiver side. For example, assuming that a gNB is capable of having maximum N beam directions, the gNB transmits signals of PSS/SSS/PBCH and the like in the N beam directions, respectively. Namely, the gNB transmits synchronization signals of PSS/SSS/PBCH and the like in the respective directions. Or, if the gNB is capable of forming N beams, a plurality of beams can be bundled into a single beam group and PSS/SSS/PBCH may be transceived per beam group. In this case, one beam group includes one or more beams. A signal of PSS/SSS/PBCH or the like transmitted in the same direction may be defined as one SS block and a plurality of SS blocks may exist within a cell. In case that a plurality of SS blocks exist, an SS block index may be used to identify each SS block. For example, when PSS/SSS/PBCH is transmitted in 10 beam directions in a single system, PSS/SSS/PBCH in the same direction may configure one SS block and 10 SS blocks may be understood as existing in the corresponding system. In the present disclosure, a beam index may be interpreted as an SS block index.

Currently, in 3GPP Release 16, i.e., standardization of an NR system, a relay gNB is under discussion for the purpose of compensating for a coverage hole but reducing wired connection between gNBs. This architecture is referred to as Integrated Access and Backhaul (IAB). A donor gNB (DgNB) transmits a signal to a UE through the relay gNB. A wireless backhaul link is configured for communication between the DgNB and the relay gNB or between relay gNBs and an access link is configured for communication between the DgNB and the UE or between the relay gNB and the UE.

A signal transmission scenario through IAB is broadly categorized into two scenarios. The first scenario is an in-band scenario in which the wireless backhaul link and the access link use the same frequency band, and the second scenario is an out-band scenario in which the wireless backhaul link and the access link use different frequency bands. Since the first scenario should also deal with interference between the wireless backhaul link and the access link, the first scenario is considered to be low relative to the second scenario in terms of ease of implementation.

The present disclosure relates to a method of configuring a different timing advance (TA) value for each gNB or a relay node by a UE when IAB is applied. More generally, a scenario in which the UE has different TA values for different beams in one cell is proposed and operations of the UE and a network for supporting the scenario are described. Currently, when data is transmitted to the UE through different TPs in the same cell, each TP may separately transmit a DL RS and a timing/frequency tracking RS. However, a TA operation is performed under the assumption that each cell belongs to one Timing Advance Group (TAG). In this case, if there is large propagation delay between the TPs, an extended CP should be used or the operation may be inefficient. This operation may be extended to a Coordinated Multi-Point (CoMP) scenario connected via ideal backhaul and a non-ideal backhaul scenario. The present disclosure is described by focusing more on the non-ideal backhaul scenario.

In the IAB scenario, two approaches may be considered in terms of a cell operation: a method of bundling partial gNBs and relay nodes as a group and operating the group with the same cell ID like one cell and a method of operating each gNB or each relay node with a different cell ID like a different cell. If a gNB and a relay node are operated with the same cell ID, since the gNB and the relay node transmit a signal on separate time/frequency resources, an influence caused by interference is further reduced as compared with the case in which the gNB and the relay node are operated with different cell IDs and thus the gNB and the relay node use overlapped resource. However, if the gNB and the relay node are operated with the same cell ID, since the resource is shared, resource efficiency is lowered. Alternatively, the throughput of the UE may increase through tighter coordination based on the same cell ID.

Although, in a non-ideal backhaul situation, it may be difficult to increase the throughput of the UE through tight coordination, if the UE is located at an edge of two TPs, frequent handover may be avoided and the TPs may be changed through beam recovery/beam management as an advantage. In addition, there is an advantage of supporting various scenarios by an operation capable of being commonly applied to a relay node and a TP. In the non-ideal backhaul situation, two TPs (e.g., a DgNB and a relay node) may appear like separate beams from the perspective of the UE and it is considered that the beams are semi-statically switched from one beam to another beam. Further, a Dynamic Point Switching (DPS) operation for selecting one of multiple beams according to resource availability or CSI of the UE while maintaining the two beams may also be considered. The present disclosure describes TA configuration during semi-static beam switching and dynamic beam switching with reference to the drawings.

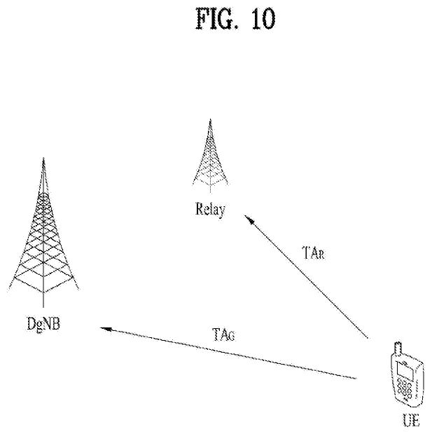

FIG. 10 illustrates an example of configuring TA values of a relay node and a DgNB by a UE.

Referring to FIG. 10, when partial DgNBs and partial relay nodes are bundled as a group and operated with the same cell ID like one cell, the DgNBs or the relay nodes included in the group may have different propagation delay (and different TA) values in terms of the UE. For example, since distance between the UE and the relay node may be different from distance between the UE and the DgNB, TA values may be different. In FIG. 10, TA_{R} represents a TA value to be applied to transmission from the UE to the relay node and TA_{G} represents a TA value to be applied to transmission from the UE to the DgNB.

If the DgNB and the relay node are operated with the same cell ID, although the DgNB and the relay node have different TA values from the UE, the DgNB and the relay node may be categorized as the same TAG in terms of a current NR system. Since the DgNB and the relay node belong to the same TAG, DgNBs or relay nodes in a group operated with the same cell ID are assumed to have the same TA value. Therefore, it is necessary to consider that even the same cell may be a different TAG.

DgNBs or relay nodes in a group operated with the same cell ID may have different TA values. Since the relay nodes and the DgNBs may not be separated from the perspective of the UE, this may mean that multiple TAGs may be allowed to be configured in one cell from the perspective of the UE. Hereinafter, a method of configuring multiple TAGs in one cell and a method of selecting a TAG during UL transmission will be described.

First, DgNBs or relay nodes in a group operated with the same cell ID may belong to different TAG groups.

When a part of the DgNBs and the relay nodes is operated with the same cell ID as one group, the UE needs to indicate different TA values upon transmitting a signal to nodes having different TA values. During initial access, the UE may transmit an RACH on an RACH resource corresponding to a beam that is determined to suit the UE. Since the selected RACH resource is associated with the beam, the DgNBs or the relay nodes may determine to which DgNB or relay node the transmitted beam belongs. In particular, since such a beam belongs to a Synchronization Signal Block (SSB) transmission resource, it may be assumed that a beam of a relay node and a beam of the DgNB transmit SSBs on different transmission resources. Thereafter, since the DgNB or the relay node transmits a Random Access Response (RAR) message to the UE, the UE may receive a TA value through the RAR. In this case, the DgNB or the relay node may determine to which DgNB or relay node the TA value is related based on the received RACH and inform the UE of the TA value related to a corresponding node.

Even when the DgNB or the relay node commands the UE to transmit the RACH through a PDCCH order, the DgNB or the relay node may inform the UE of the TA value by a random access procedure through the RAR during initial access described above.

A scheme of operating a plurality of TAGS may be considered as follows.
Whether each TAG is related to a DgNB or a relay node may be indicated through an RACH resource. The UE separately manages TAGs for the DgNB and the relay node based on RACH transmission under the assumption that the DgNB and the relay node are operated as different TAGs.
Information about a DL beam to which each TAG is applied is provided. In other words, to which TAG each of multiple Transmission Configuration Indicator (TCI) states provided to the UE belongs is indicated. The UE shares a TA update procedure with respect to TCI states having the same TAG.
Which TAG is applied to each RACH resource may be indicated through RAR, Msg4, or RRC. The TAG may be newly generated during RACH transmission and may be invalidated through an RRC/MAC Control Element (CE). It is assumed that TA is applied based on a timing for a DL beam corresponding to a related RACH resource.
Information about a TAG applied to each SRS Resource Indicator (SRI) is provided. That is, to which TAG each of multiple SRI states belongs is indicated to the UE. The UE shares the TA update procedure with respect to SRI states having the same TAG.

The UE transmits a PUCCH/PUSCH and an SRS based on a TA value indicated by the gNB (e.g., provided during initial access, during an RACH procedure according to a PDCCH order, or through a MAC CE). In this situation, the gNB may recognize a situation in which a beam suitable for the UE is changed. For example, a beam failure condition is satisfied or the gNB may determine that a currently applied beam of the UE is not the best beam by receiving an SRS of another beam.

In this case, not only a beam but also a direction of a transmission beam of the UE corresponding to the best beam, which is directed toward the DgNB or the relay node, may be changed. In other words, the transmission beam of the UE which is best for the DgNB may be changed to the transmission beam of the UE which is best for the relay node, or the transmission beam of the UE which is best for the relay node may be changed to the transmission beam of the UE which is best for the DgNB. This situation may occur between the relay node and another relay node when there are multiple relay nodes and occur between the DgNB and another DgNB when there are multiple DgNBs. This means that the situation may include a process in which a transmission target is changed to a proper node among the DgNB and the relay node as the transmission beam of the UE is changed. Therefore, this situation indicating that the DgNB or the relay node suitable for the UE is changed may occur depending on to which node a TA value is transmitted when the UE transmits the PUSCH/PUCCH/SRS.

Assuming that TA which varies as the transmission beam of the UE is changed is considered with a sufficient time, the DgNB or the relay node may cause the UE to transmit an RACH through a PDCCH order. Then, the TA value is transmitted through an RAR so that the UE may apply a proper TA value without being aware of whether a target node is the DgNB or the relay node.

However, a few other operations may be needed in order for the UE to perform UL transmission while dynamically changing a beam in a situation in which a beam is changed and thus a node is also changed according to the changed beam, so that TA is changed.

<Operation Based on UL Grant>

When DCI carrying a UL grant indicates an SRI representing a beam for PUSCH transmission, the DCI may also indicate with which node or to which TAG (i.e., which DgNB or which relay node) the beam is associated. The UE transmits a PUSCH by applying a proper TA according to a related node or a related TAG. Alternatively, the DCI may directly indicate a TAG index. The UE performs UL transmission by applying TA in a corresponding TAG. An option for configuring the TAG for the UE has been described above.

When updating TA for each TAG, TA may be updated by the following methods.

<A> A TAG index may be directly included in a TA update command. A command received with respect to each TAG is applied. TA values of multiple TAGS may be updated through one message. Information about a DL beam/time/frequency that a corresponding TAG refers to is differently configured according to the above scheme. For example, the information about the DL beam/time/frequency that a corresponding TAG refers to is differently configured according to a relay node or a DgNB, a currently configured TCI state and TAG index, or an SRI resource.

Alternatively, as an implicit method, TA of a TAG associated with a TCI state of DL transmission carrying a TA command is updated. When a DgNB transmits data, TA of a TAG of the DgNB is updated and, when a relay node transmits data, TA of a TAG of the relay node is updated. This operation is equally performed even with respect to another beam. For a beam, it is assumed that a DL TCI state is associated with a TAG and the TAG is also associated with a UL beam direction. This association may be explicitly signaled by a network and the same indexes may be implicitly associated.

<B> DCI may indicate a related node or a related TAG to the UE, and a TA value of each node or each TAG may be updated or configured through a MAC CE transmitted prior to DCI transmission.

<C> DCI may indicate a related node or a related TAG to the UE, and a TA value of each node or each TAG may be updated or configured through an RAR transmitted prior to DCI transmission.

Particularly, the TA value of each node or each TAG may be indicated through an RAR by each node. A separate RAR may be configured for each node or each TAG on an RAR resource. Alternatively, as the TA value of each node or each TAG, the DgNB or the relay node may indicate all TA values through one RAR.

<D> DCI may indicate a related node or a related TAG to the UE and also indicate a TCI suitable for an SRI indicated by the DCI among TCIs corresponding to DgNB beam information to indicate pair information of a beam of the DgNB and a transmission beam of the UE.

Similarly, the TA value of each node or each TAG may be indicated through an RAR by each node. A separate RAR may be configured for each node or each TAG on an RAR resource. Alternatively, as the TA value of each node or each TAG, the DgNB or the relay node may indicate all TA values through one RAR.

<E>DCI may not indicate a related node or a related TAG and may indicate a TCI suitable for an SRI indicated by the DCI among TCIs corresponding to DgNB beam information to indicate pair information of a beam of the DgNB and a transmission beam of the UE. Similarly, as a TA value of each beam, the DgNB or the relay node may indicate all TA values through one RAR.

<F> When SRS configuration for an SRS transmission resource and an SRS transmission method is performed, a related node, a related TAG, or a beam of a related TAG (or TA value) may also be indicated according to an SRS resource. Since the SRS resource is associated with an SRI, the UE applies a TA value applied to the SRS resource to a value associated with a resource indicated by the SRI.

<Operation Based on DL Grant>

The UE recognizes a beam thereof for ACK/NACK transmission for PDSCH transmission in DCI carrying a DL grant through information of a DL transmission beam of the DgNB. Therefore, with which a node or which TAG (i.e., which DgNB or relay node) the DL transmission beam is associated may also be indicated. The UE transmits ACK/NACK by applying a proper TA according to a related node or a related TAG. Alternatively, the DCI may directly indicate a TAG index. The UE performs UL transmission by applying TA in a corresponding TAG. An option for configuring the TAG for the UE has been described above. When updating TA for each TAG, TA may be updated by the following method.

<A> A TAG index is included in a TA update command. A command received with respect to each TAG is applied. TA values of multiple TAGs may be updated through one message. Information about a DL beam/time/frequency that a corresponding TAG refers to is differently configured according to the above scheme. For example, the information about the DL beam/time/frequency that a corresponding TAG refers to is differently configured according to a relay node or a DgNB, a currently configured TCI state and TAG index, or an SRI resource.

<B> As an implicit method, TA of a TAG associated with a TCI state of DL transmission carrying a TA command is updated. When a DgNB transmits data, TA of a TAG of the DgNB is updated and, when a relay node transmits data, TA of a TAG of the relay node is updated. This operation is equally performed even with respect to another beam. For a beam, it is assumed that a DL TCI state is associated with a TAG and the TAG is also associated with a UL beam direction. This association may be explicitly signaled by the network and the same indexes may be implicitly associated.

<C> DCI may indicate a related node or a related TAG to the UE, and a TA value of each node or each TAG may be indicated through a MAC CE transmitted prior to DCI transmission.

<D> DCI may indicate a related node or a related TAG to the UE, and a TA value of each node or each TAG may be indicated through an RAR transmitted prior to DCI transmission.

Particularly, the TA value of each node or each TAG may be indicated through an RAR by each node. A separate RAR may be configured for each node or each TAG on an RAR resource. Alternatively, as the TA value of each node or each TAG, the DgNB or the relay node may indicate all TA values through one RAR.

<Operation Based on SRS Configuration>

When SRS configuration for an SRS transmission resource and an SRS transmission method is performed, a beam of a related node (or TA value) is indicated according to an SRS resource. A suitable RA is applied to each SRS beam according to this node information and is then transmitted.

A) In the case of an aperiodic SRS, DCI may indicate a related node or a related TAG to the UE, and a TA value of each node or each TAG may be indicated through a MAC CE transmitted prior to DCI transmission.

Particularly, in the case of the aperiodic SRS, DCI may indicate a related node or a related TAG to the UE, and a TA value of each node or each TAG may be indicated through an RAR transmitted prior to DCI transmission. The TA value of each node or each TAG may be indicated through an RAR by each node. A separate RAR may be configured for each node or each TAG on an RAR resource. As the TA value of each node or each TAG, the DgNB or the relay node may indicate all TA values through one RAR.

B) In the case of an aperiodic SRS, DCI may indicate a related node or a related TAG to the UE, and a TCI suitable for an SRS beam among TCIs corresponding to DgNB beam information is signaled through DCI or RRC to indicate pair information of a beam of the DgNB and a transmission beam of the UE. The TA value of each node or each TAG may be indicated through an RAR by each node, and a separate RAR may be configured for each node or each TAG on an RAR resource. Alternatively, as the TA value of each node or each TAG, the DgNB or the relay node may indicate all TA values through one RAR.

C) In the case of an aperiodic SRS, DCI may not indicate a related node or a related TAG to the UE, and a TCI suitable for an SRS beam among TCIs corresponding to DgNB beam information is signaled through DCI or RRC to indicate pair information of a beam of the DgNB and a transmission beam of the UE. If the TCI is signaled through RRC, a TA value suitable for the SRS beam may be directly indicated. As a TA value for each beam, the DgNB or the relay node may indicate all TA values through one RAR.

D) In the case of a semi-persistent SRS, all TA information according to an SRS beam or an SRS resource may be indicated through a MAC CE triggering the semi-persistent SRS.

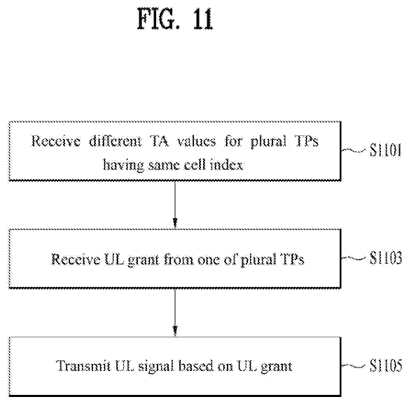

FIG. 11 is a flowchart illustrating an example of configuring a plurality of TA values according to an embodiment of the present disclosure. In FIG. 11, it is assumed that the UE transmits and receives a signal to and from a plurality of TPs having the same cell index.

Referring to FIG. 11, the UE receives information about different TA values for a plurality of TPs having the same cell index in step 1101. As described above, the information about the TA values may be received through an RAR signal from one or more of the plural TPs.

Next, the UE receives a UL grant from one of the plural TPs in step 1103. The UL grant indicates one of a plurality of beam indexes for transmitting a UL signal. The indicated beam index may correspond to one of the plural TPs.

Finally, the UE transmits the UL signal based on the UL grant in step 1105. The UL signal may be transmitted by applying TA associated with the indicated beam index.

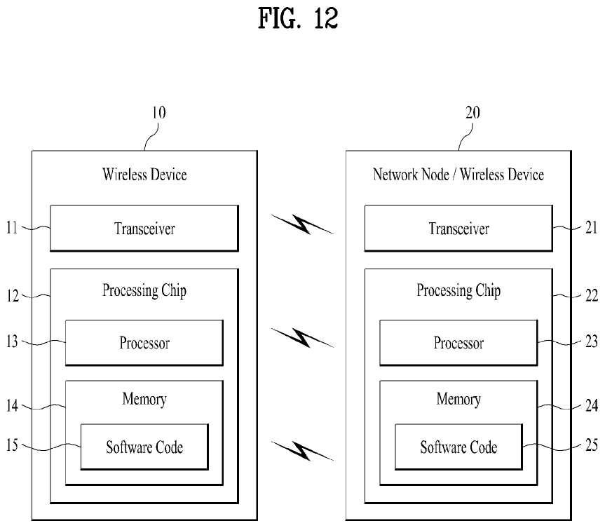

FIG. 12 is a block diagram showing an example of communication between a wireless device 10 and a network node 20. Here, the network node 20 may be substituted with the wireless device 10 of FIG. 11 or a UE.

In the present specification, the wireless device 10 or the network node 20 includes a transceiver 11/21 configured to communicate with one or more other wireless devices, network nodes and/or other elements of a network. The transceiver 11/21 may include one or more transmitters, one or more receivers, and/or one or more communication interfaces.

The transceiver 11/12 may include one or more antennas. The antenna performs a function of transmitting a signal processed by the transceiver 11/12 externally or a function of receiving a wireless signal from outside and forwarding it to a processing chip 12/22. The antenna may be referred to as an antenna port. Each antenna corresponds to a single physical antenna or may be configured with a combination of two or more physical antenna elements. A signal transmitted from each antenna cannot be further resolved by the wireless device 10 or the network node 20. A Reference Signal (RS) transmitted in correspondence to a corresponding antenna defines an antenna from the perspective of the wireless device 10 or the network node 20 and enables the wireless device 10 or the network node 20 to perform channel estimation on the antenna irrespective of whether a channel is a single wireless channel from one physical antenna or a composite channel from a plurality of physical antenna elements including the above antenna. Namely, an antenna is defined in a manner that a channel delivering a symbol on the antenna can be derived from the channel delivering another symbol on the same antenna. If a transceiver supports Multiple Input Multiple Output (MIMO) of transceiving data using a plurality of antennas, it may be connected to two or more antennas.

In the present disclosure, the transceiver 11/12 may support an Rx beamforming and a Tx beamforming. For example, in the present disclosure, the transceiver 11/12 may be configured to perform the functions exampled in FIGS. 7 to 9.

The wireless device 10 or the network node 20 includes the processing chip 12/22. The processing chip 12/22 may include at least one processor such as a processor 13/23 and at least one memory device such as a memory 14/24.

The processing chip 12/22 may control at least one of the methods and/or processes described in the present specification. So to speak, the processing chip 12/22 may be configured to implement at least one or more embodiments disclosed in the present specification.

The processor 13 or 23 includes at least one processor configured to execute the functions of the wireless device 10 or the network node 20 described in the present specification.

For example, one or more processors control the one or more transceivers 11/21 shown in FIG. 12 to transceive information.

The processor 13/23 included in the processing chip 12/22 performs prescribed coding and modulation on a signal and/or data to be transmitted out of the wireless device 10 or the network node 20 and then transmits it to the transceiver 11/21. For example, the processor 13/23 transforms a data column to transmit into K layers through demultiplexing & channel coding, scrambling, modulation and the like. The coded data column may be referred to as a codeword and is equivalent to a transport block that is a data block provided by a MAC layer. One Transport Block (TB) is coded into one codeword, and each codeword is transmitted to a receiving device in form of one or more layers. The transceiver 11/12 may include an oscillator for frequency upconversion. The transceiver 11/12 may include Nt Tx antennas, where Nt is a positive integer equal to or greater than 1.

The processing chip 12/22 includes a memory 14/24 configured to store data, programmable software code and/or other information to execute the embodiments described in the present specification.

So to speak, in an embodiment according to the present specification, when the memory 14/24 is executed by at least one processor such as the processor 13/23, the memory 14/24 stores a software code 15/25 including commands for enabling the processor 13/23 to execute processes controlled by the processor 13/23 entirely or in part or commands for executing the embodiments described in the present specification.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by a subsequent amendment after the application is filed.

A specific operation described as performed by a BS may be performed by an upper node of the BS in the present disclosure. Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘Access Point (AP)’, etc.

The embodiments of the present disclosure may be achieved by various means, for example, hardware, firmware, software, or a combination thereof. In a hardware configuration, the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, the embodiments of the present disclosure may be achieved by a module, a procedure, a function, etc. performing the above-described functions or operations. Software code may be stored in a memory unit and driven by a processor. The memory unit is located at the interior or exterior of the processor and may transmit data to and receive data from the processor via various known means.

It will be apparent to those skilled in the art that various modifications and variations can be made in the present disclosure without departing from the spirit or scope of the disclosure. Therefore, the above-mentioned detailed description must be considered only for illustrative purposes instead of restrictive purposes. The scope of the present disclosure must be decided by a rational analysis of the claims, and all modifications within equivalent ranges of the present disclosure are within the scope of the present disclosure.

1. A method of transmitting an uplink signal in a next-generation wireless communication system, the method comprising:
receiving information about different timing advance values for a plurality of transmission points having an equal cell index;
receiving an uplink grant from one of the plural transmission points; and
transmitting the uplink signal based on the uplink grant,
wherein the uplink grant indicates one of a plurality of beam indexes for transmitting the uplink signal, and
wherein the uplink signal is transmitted by applying timing advance associated with the indicated one beam index.

2. The method of claim 1, wherein the information about the timing advance values is received through a random access response signal from one or more of the plural transmission points.

3. The method of claim 1, wherein the plural transmission points include a doner base station and a relay node connected to the doner base station.

4. The method of claim 1, wherein the plural transmission points having the equal cell index belong to different timing advance groups.

5. A user equipment (UE) in a next-generation wireless communication system, the UE comprising:
a wireless communication module; and
at least one processor connected to the wireless communication module,
wherein the at least one processor controls the wireless communication module to receive information about different timing advance values for a plurality of transmission points having an equal cell index, receive an uplink grant from one of the plural transmission points, and transmit the uplink signal based on the uplink grant,
wherein the uplink grant indicates one of a plurality of beam indexes for transmitting the uplink signal, and
wherein the uplink signal is transmitted by applying timing advance associated with the indicated one beam index.

6. The UE of claim 5, wherein the information about the timing advance values is received through a random access response signal from one or more of the plural transmission points.

7. The UE of claim 5, wherein the plural transmission points include a doner base station and a relay node connected to the doner base station.

8. The UE of claim 5, wherein the plural transmission points having the equal cell index belong to different timing advance groups.
